(19) United States
(12) Patent Application Publication
(10) Pub. No.: US 2026/0316277 A1
(43) Pub. Date: Oct. 15, 2026

(54) COLLABORATIVE ROBOT SYSTEM

(71) Applicant: NACHI-FUJIKOSHI CORP., Tokyo (JP)

(72) Inventor: Takuma NIIHARA, Toyama-shi (JP)

(21) Appl. No.: 19/220,544

(22) Filed: May 28, 2025

(30) Foreign Application Priority Data
Jun. 4, 2024 (JP) 2024-090912

(51) Int. Cl. B25J 9/16; B25J 13/08

(52) U.S. Cl. CPC B25J 9/1674; B25J 13/085

(57) ABSTRACT

A collaborative robot system includes a robot and a controller. In response to a determination by the controller that an external torque applied to a joint of the robot is equal to or greater than a first threshold, the robot is placed on hold of an operation. While the robot is on hold, in response to a determination by the at least one processor that an updated external torque is equal to or greater than a second threshold, the at least one processor further determines if the updated external torque is equal to or greater than a third threshold. In response to a determination that the updated external torque is equal to or greater than the third threshold, the at least one processor avoids invoking an escape mode. Otherwise, the at least one processor invokes the escape mode.

### RELATED APPLICATIONS

This application claims priority to Japanese Patent Application No. JP 2024-090912, filed on Jun. 4, 2024, the entire content of which is incorporated herein by reference.

### BACKGROUND OF THE INVENTION

### 1. Field of the Invention

The present invention relates to a collaborative robot system that performs the collision detection function and the escape mode function.

### 2. Description of the Related Art

In general, a collaborative robot system is built to be operable to perform the collision detection function that safely places the collaborative robot on hold of operation upon detection of a collision between the collaborative robot and an operator or the like. As an example of the collision detection function, a method is known that estimates an external torque and places the collaborative robot on hold if the external torque is greater than or equal to a threshold, where the external torque is the difference between a torque measured by a torque sensor and a theoretical torque calculated using a point mass model in which the arm of the robot, a tool of the robot and a workpiece are all replaced with their masses concentrated at their centers of gravity.

Additionally, when the collaborative robot is placed on hold after the detection of a collision, the operator may be trapped and restrained between the collaborative robot and an object. In order to avoid the operator from remaining trapped, an escape mode function has been proposed that can help the trapped operator free himself from being trapped. Japanese Patent Publication No. 7260727 discloses an exemplary escape mode function in which the trapped operator pushes the arm of the collaborative robot to direct the arm to perform a retreating mode function at each of its axes to free the trapped operator.

The proper operations of the collision detection function and the escape mode function mentioned above are conditioned upon the accurate estimation of external force. In order to accurately estimate the external force, it is indispensable, after the installation of the robot, to calibrate the sensors and to preset accurate profile values of the tool of the robot and the workpiece. Japanese Patent Publication No. 7288158 discloses a load verification mandatorily performed at every power-on to verify that the selected load setting matches the actual load of the robot.

### SUMMARY OF THE INVENTION

However, it is troublesome to be mandatorily required at every power-on to perform the load verification. Additionally, the load verification may not result in the accurate estimation of the external force, because of an oversight of errors in the inputted profile values or faulty measurements by the torque sensor.

When the external force cannot be accurately estimated, a robot control device may mistakenly determine that it is pushed by a person in the escape mode function, although it is not actually the case, and incorrectly control the operation of the robot. This may result, for example, in that a workpiece gripped by the tool may be dropped or the arm may collide with an object.

The present invention has been made in view of the problems described above, and has an object to ensure safety in the operation of a collaborative robot system that executes the collision detection function and the escape mode function, even where external force cannot be accurately estimated. More specifically, the present invention has an object to avoid the robot from being faultily placed in the escape mode, where the external force cannot be accurately estimated, in order to prevent mishandling of a workpiece gripped by the robot and a collision of the robot with an object, which may be caused by faulty placement of the robot in the escape mode.

A collaborative robot system according to the present invention includes at least one processor programmed to execute the collision detection function and the escape mode function. The robot is formed with joints articulable to move a tool in an operation for processing a workpiece, and at least some of the joints are equipped with a torque sensor for measuring a torque exerted on the joints of the robot.

The collaborative robot system according to the present invention comprises a controller with at least one processor. In the present invention, the at least one processor is programmed to execute three comparisons, a first comparison, a second comparison and a third comparison, to evaluate an external toque exerted on the joints of the robot to determine if the robot collides with an external object, if the robot is pushed by an external force or if something unordinary happens that causes the external force to have an unordinary value. The external torque is a difference between a measured torque, from the torque sensor, actually applied to the joints of the robot, and an estimated operation torque calculated using a point mass model. The estimated operation torque is indicative of a theoretical toque value mathematically calculated to estimate an operation torque applied to the joints of the robot in the operation for processing the workpiece.

The at least one processor is programmed to execute the first comparison in which the at least one processor receives the measured torque from the torque sensor, estimates a theoretical value of an operation torque using the point mass model, and compares the estimated operation torque and the measured torque to derive a first differential torque. Since the estimated operation torque is considered a torque theoretically applied to the joints of the robot during the operation for processing the workpiece, the first differential toque is considered a toque externally exerted on the joints of the robots. Upon a determination that the first differential torque is equal to or greater than a first threshold, the at least one processor places the robot on hold of the operation for processing the workpiece. The first differential torque equal to or greater than the first threshold may be considered an indication of the robot being in collision with an external object.

The at least one processor is programmed to execute the second comparison, while the robot is on hold of the operation for processing the workpiece, in which the at least one processor receives an updated measured torque from the torque sensor, updates the estimated operation torque applied to the joint, using the point mass model, and compares the updated estimated operation torque and the updated measured torque to derive a second differential torque between them. Upon a determination that the second differential torque is equal to or greater than a second threshold, the at least one processor, while the robot is on hold of the operation for processing the workpiece, executes a third comparison, in which the at least one processor compares the second differential torque with a third threshold.

The second differential toque equal to or greater than the second threshold may be considered a torque externally applied by a human operator to push the arm of the robot away from the operator to try to free the operator himself from being trapped by the arm of the robot. In the present invention, however, even where the second differential toque is determined equal to or greater than the second threshold, the at least one processor, instead of placing the robot in the escape mode, proceeds to further compare the second differential torque with the third threshold.

The third threshold represents an unordinary external torque. The second differential torque equal to or greater than the third threshold suggests that something unordinary happens in measurements of the actual torque applied to the joints of the robot, such as caused by an oversight of errors in the inputted profile values or faulty measurements by the torque sensor. In other words, the second differential torque equal to or greater than the third threshold may suggest that something unordinary happens other than an operator being trapped by the robot. The escape mode, if invoked in a situation where an operator is not trapped, may cause mishandling of a workpiece gripped by the robot or a collision of the robot with an object. In the present invention, accordingly, even where the second differential toque is found equal to or greater than the second threshold, the at least one processor does not invoke the escape mode but wait to confirm that the second differential torque is found smaller than the third threshold, before invoking the escape mode.

If the second differential torque is found equal to or greater than the third threshold, the at least one processor does not invoke the escape mode and proceed back to execute the second comparison after an elapse of a certain time.

Another aspect of the present invention is that the at least one processor maintains the robot being in the escape mode until an occurrence of one of release conditions that include an elapse of a second predetermined time and a reception of an instruction to release the robot from being in the escape mode.

Another aspect of the present invention is that the first, second and third threshold hold the following relationships:
the first threshold<the second threshold<third threshold.

Another aspect of the present invention is that the at least one processor executes a Newton-Euler equation using the point mass model to estimate the operation torque.

A further aspect of the present invention is that the at least one processor establishes the point mass model in which the arm of the robot and the workpiece in the operation of processing the workpiece are replaced with their masses concentrated at their centers of gravity.

Still another aspect of the present invention is that the third threshold is selected to reflect a difference between the estimated operation torque calculated where the mass of the workpiece is replaced with a load capacity of the robot and the estimated operation torque calculated where the mass of the workpiece is replaced with a zero mass.

Still another aspect of the present invention is that the third threshold is selected to reflect an average human force used to push the arm of the robot.

The present invention ensures safety even in situations where external force cannot be accurately estimated in a collaborative robot system that performs the collision detection function and the escape mode function.

### BRIEF DESCRIPTION OF THE DRAWINGS

FIG. 1 is a schematic view illustrating a collaborative robot system of an embodiment of the present invention.

FIG. 2 is a flow chart illustrating an exemplary process flow performed by a controller of FIG. 1.

### DETAILED DESCRIPTION OF THE PREFERRED EMBODIMENTS

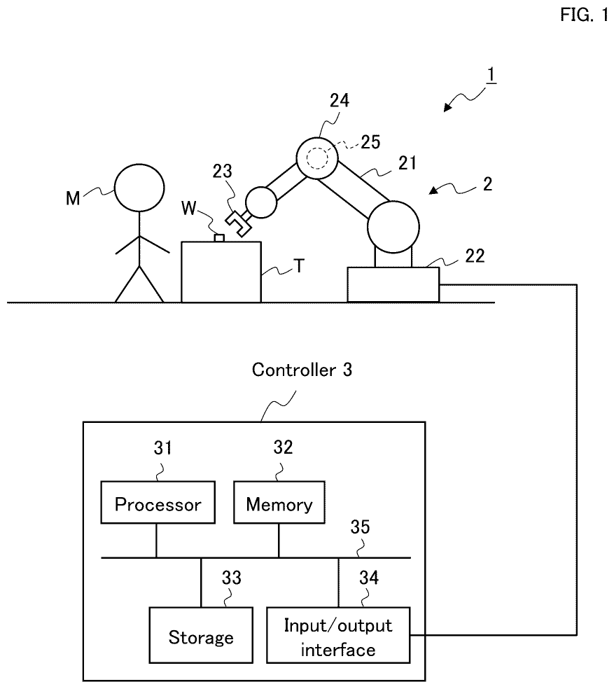

Hereinafter, the present invention will be described in detail with reference to the drawings. FIG. 1 is a schematic view illustrating a collaborative robot system according to an embodiment of the present invention. As illustrated in FIG. 1, a collaborative robot system 1 includes a collaborative robot 2 and a controller 3 that controls the operation of the collaborative robot 2. The collaborative robot 2 is capable of working collaboratively with an operator M in a certain collaborative workspace. The collaborative robot 2 and the operator M work collaboratively, for example, on a workpiece W placed on a table T.

The collaborative robot 2 has a mounting base 22 that supports an arm 21. A tool 23 is attached to a distal end of the arm 21. The arm 21 is formed of a link mechanism having a plurality of links and has joints 24 that connect the links. Each joint 24 is provided with a drive motor, not shown, and a torque sensor 25 that measures a torque applied to the joint 24 of the collaborative robot 2. Although only one torque sensor 25 is illustrated in FIG. 1, a plurality of the torque sensors 25 may be provided, and one torque sensor 25 may be provided to each of some or all of the joints 24. The torque sensor 25 is regularly inspected and calibrated after the collaborative robot 2 is installed.

An example of the collaborative robot 2 includes a vertically articulated multi-joint robot having six joints 24. However, the present invention can also be applied to a robot having five or less or seven or more joints 24, a horizontally articulated multi-joint robot or the like. Additionally, the collaborative robot 2 is not limited to a single-arm robot and may be a two-arm robot.

The controller 3 may be built into the mounting base 22 of the collaborative robot 2 or may be installed alongside the collaborative robot 2. In the latter case, the collaborative robot 2 and the controller 3 are communicatively connected via communication cables or wirelessly.

A processor 31, a memory 32, a storage 33, and an input/output interface 34 of the controller 3 are connected via a bus 35. The processor 31 reads a computer program stored in advance in the storage 33 and the like and deploys it into the memory 32 for sequential execution of a plurality of commands. The storage 33 is a hard disc drive, a solid-state drive, or the like, and stores data used for the processes described below. The input/output interface 34 receives signals from the collaborative robot 2, a teaching pendant (not shown), and other devices, and returns signals thereto.

The collaborative robot system 1 according to the embodiment executes a collision detection function that safely places the collaborative robot 2 on hold upon a detection of a collision between the collaborative robot 2 and the operator M or the like. Additionally, the collaborative robot system 1 executes an escape mode function that helps the operator M free himself from being trapped between the collaborative robot 2 and an external object (the table T or the like in FIG. 1) when the collaborative robot 2 is placed on hold by the collision detection function. The escape mode function according to the embodiment is implemented such that when the arm 21 of the collaborative robot 2 is pushed by an external force, the controller 3 controls the operation of the collaborative robot 2 to move the arm 21 in the direction it is pushed. The collision detection function and the escape mode function are implemented to ensure safety by the controller 3 controlling the operation of the collaborative robot 2 in such a manner as discussed below.

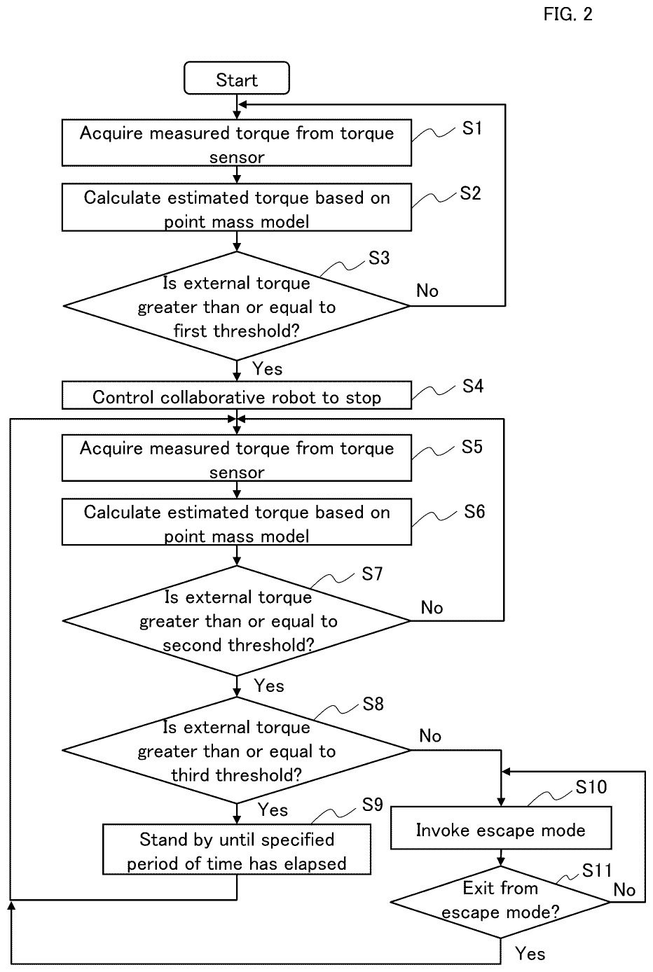

FIG. 2 is a flow chart illustrating an exemplary process flow performed by the controller of FIG. 1. As illustrated in FIG. 2, the controller 3 acquires a torque measured at each joint 24 by the torque sensor 25 provided to the joint 24 (step S1). The controller 3 then uses a point mass model to calculate an estimated operation torque at each joint 24 for which the torque sensor 25 is provided (step S2).

The estimated operation torque can be calculated using a model such as expressed by Equation 1 below, using, for example, the Newton-Euler method.

Estimated torque=f(d, m, x) (Equation 1)
f: Drive torque calculation function of the Newton-Euler method or the like
d: Link parameters (DH parameter)
m: Point mass model (masses, centers of gravity, and the like, of the arm 21, the tool 23, and the workpiece W)
x: Positions of each axis

The Newton-Euler method is a technique that treats restricting forces and relative motions between links as vector quantities and solves an equation of motion under the balance stricken between the forces and the moments. The link parameters are parameters that define geometrical positional relationships between the links of the arm 21 and the joints 24. The DH parameters using the Denavit-Hartenberg notation (DH method) are known as such. The point mass model provides a simplified simulation of the robot mechanism in which a point mass is assigned to each joint and the like of the robot. The point mass model according to the embodiment simulates the masses of the arm 21, the tool 23 of the collaborative robot 2 and the workpiece W concentrated at their centers of gravity. Among the parameters included in Equation (1), profile values of the masses and the like of the tool 23 and the workpiece W are inputted by the operator M and stored in the controller 3.

For each joint 24 for which the torque sensor 25 is provided, the controller 3 determines an external torque which is a difference between the torque measured by the torque sensor 25 and an estimated operation torque calculated using the point mass model and verifies whether the external torque is greater than or equal to a first threshold (step S3). The first threshold is set equal to a value for use in determining whether a collision occurs between the collaborative robot 2 and an external object (the operator M, the table T, or the like). If the external torque determined with respect to at least one joint 24 is greater than or equal to the first threshold (Yes in step S3), the controller 3 places the collaborative robot 2 on hold of the operation for processing the workpiece W (step S4). Alternatively, if the external torques determined with respect to all the joints 24 are less than the first threshold (No in step S3), the controller 3 repeats the processes from step S1.

After confirming that the collaborative robot 2 is on hold (step 4), the controller 3 acquires an updated torque measured by the torque sensor 25 (step S5) and calculates an updated estimated operation torque at each joint 24 using the point mass model (step S6) as performed in steps S1 and S2. The controller 3 then determines whether the updated external torque is greater than or equal to a second threshold (step S7). The second threshold is a threshold, different from the first threshold, for use in determining whether the arm 21 is pushed by an external force. If the updated external torque is greater than or equal to the second threshold (Yes in step S7), the controller 3 proceeds to perform a threshold determination in step S8. Alternatively, if the updated external torque is less than the second threshold (No in step S7), the controller 3 repeats the processes from step S5.

The controller 3 then determines whether the updated external torque is greater than or equal to a third threshold (step S8). The third threshold is a threshold, different from the first or second threshold, for use in determining whether the updated external torque has an unordinary value. If the updated external torque is greater than or equal to the third threshold (Yes in step S8), the controller 3 maintains the robot being on hold without invoking the escape mode, which helps the operator M free himself, until a predetermined period of time has elapsed (step S9), and repeats the processes from step S5 after the predetermined period of time elapses. During the process in step S9, the collaborative robot 2 is kept on hold of the operation for processing the workpiece W. Alternatively, if the updated external torque is less than the third threshold (No in step S8), the controller 3 invokes the escape mode and transitions to the process in the escape mode (step S10).

Since the updated external torque is a difference between the measured torque and the estimated operation torque, it is possible that the controller 3 cannot accurately estimate the external torque, where there are errors in the measurements of the torque sensor 25, or there are errors in the inputted profile values of the masses and the like of the tool 23 and the workpiece W. Thus, as shown in steps from S8 to S10, if the external torque has an unordinary value, the controller 3 does not invoke the escape mode. This process functions to avoid the tool 23 from dropping the workpiece W or the arm 21 from colliding with an external object such as the table T.

For example, if the updated external torque is determined to have an unordinary value in the determination process in step S8, the controller 3 may output a warning sound or a warning message to notify the operator M that the external torque is determined to have an unordinary value. This allows the operator M to take appropriate measures during the predetermined period of time in step S9.

In the process performed in the escape mode in step S10, the controller 3 controls the operation of the collaborative robot 2 to move the arm 21 in the direction in which it is pushed. For example, the controller 3 may move the arm 21 for a certain distance in the direction it is pushed, or move the arm 21 in the direction it is pushed only while being pushed.

While the escape mode is in operation, the controller 3 determines whether to exit from the escape mode (step S11). After the controller 3 exits from the escape mode (Yes in step S11), the controller 3 returns to step S5 and repeats the processes from step S5. If the controller 3 decides to stay in the escape mode (No in step S11), the controller 3 continues going back to the escape mode process in step S10. The conditions for exiting from the escape mode include, for example, whether a predetermined period of time elapses from the start of the escape mode, and whether an interrupt notification is received that requests to exit from the escape mode. For example, the interrupt notification is transmitted to the controller 3 when the operator M presses an escape mode termination button of the teaching pendant and other cases.

The thresholds used in steps S3, S7, and S8 will further be described. The first threshold has a relatively small value set to detect an external force indicative of a collision of the robot with an external object. The second threshold has a value, greater than the first threshold, set to detect an external torque indicative of the robot being pushed by a human. The third threshold has a value, greater than the second threshold, set to detect that an external torque has an unordinary value. The three thresholds have a relationship expressed by the first threshold<the second threshold<the third threshold. However, in the present invention, the relationship of the three thresholds is not limited thereto.

The third threshold may take a value that reflects the load capacity of the collaborative robot 2 for carrying a workpiece. For example, despite the fact that the tool 23 is actually in hold of the workpiece W, if it is incorrectly determined that the tool 23 does not grip the workpiece W, the controller 3 estimates the external torque that is incorrect by the mass of the workpiece W. Thus, the third threshold may be set equal to a value derived from a difference between the estimated operation torque calculated, where the mass of the workpiece W is set in the point mass model to the load capacity of the collaborative robot 2 for carrying the workpiece W, and the estimated operation torque calculated, where the mass of the workpiece W is set equal to zero. The value derived from the difference between the two estimated operation torques is not limited to the value derived from the difference between the two estimated operation torques as such, but the value may take a value derived from the difference between the two estimated operation torques multiplied by a coefficient, a value obtained by adding or subtracting a constant to or from the difference between the two estimated operation torques, or the like.

Additionally, since the third threshold takes a value for use in determining whether a push force exerted by a human has an unordinary value, it may take a value reflecting the strength of an average human force. Furthermore, the third threshold may take a value changeable by the operator M when the collaborative robot 2 is installed.

As described above, in the collaborative robot system 1 of the present invention, the controller 3 does not invoke the escape mode if the updated external torque has an unordinary value. This process ensures safety even where the external force cannot be accurately estimated.

Although the preferred embodiments of the collaborative robot system and the like according to the present invention have been described above with reference to the accompanying drawings, the present invention is not limited to these examples. It is obvious for those skilled in the art that various modification examples or correction examples may be conceived of within the range of the technical idea disclosed in the present application, and it is understood that they will also naturally fall within the technical scope of the present invention.

What is claimed is:

1. A collaborative robot system comprising:
a collaborative robot having an arm having a distal end to which a tool is attached, the arm being formed with joints articulable to move the tool in an operation for processing a workpiece, wherein at least some of the joints include a torque sensor operable to measure a torque exerted on the joint to which the torque sensor is provided; and
a controller configured to control operation of the collaborative robot, wherein the controller includes at least one processor programmed to:
(a) execute, with the robot being in the operation for processing the workpiece, a first comparison comprising: receiving the measured torque from the torque sensor; estimating an operation torque applied to the joint, wherein the operation torque is estimated using a point mass model; and comparing the estimated operation torque and the measured torque to derive a first differential torque between them;
(b) upon a determination that the first differential torque is greater than or equal to a first threshold, place the robot on hold of the operation for processing the workpiece;
(c) execute, with the robot being on hold of the operation, a second comparison comprising: receiving an updated measured torque from the torque sensor; updating the estimated operation torque applied to the joint, using the point mass model; and comparing the updated estimated operation torque and the updated measured torque to derive a second differential torque between them;
(d) upon a determination that the second differential torque is greater than or equal to a second threshold, execute, with the robot being on hold of the operation for processing the workpiece, a third comparison comprising comparing the second differential torque with a third threshold;
(e) upon a determination that the second differential torque is equal to or greater than the third threshold, avoid invoking an escape mode and maintain the robot being on hold of the operation for processing the workpiece; and
(f) upon a determination that the second differential torque is smaller than the third threshold, invoke the escape mode, in which the controller passively follows an external force applied to the arm of the robot to move the robot in a direction of the external force.

2. The collaborative robot system according to claim 1, wherein the at least one processor is further programmed to return to step (a) upon a determination that the first differential torque is smaller than the first threshold.

3. The collaborative robot system according to claim 1, wherein the at least one processor is further programmed to return to step (c) upon a determination that the second differential torque is smaller than the second threshold.

4. The collaborative robot system according to claim 1, wherein the at least one processor is further programmed to, subsequent to step (e), return to step (c) upon an elapse of a first predetermined time.

5. The collaborative robot system according to claim 1, wherein the at least one processor is further programmed to, subsequent to execution of step (f), maintain the robot being in the escape mode until an occurrence of one of release conditions that include an elapse of a second predetermined time and a reception of an instruction to release the robot from being in the escape mode.

6. The collaborative robot system according to claim 1, wherein the first, second and third threshold hold the following relationships:
the first threshold<the second threshold<third threshold.

7. The collaborative robot system according to claim 1, wherein the at least one processor is further programmed to execute a Newton-Euler equation using the point mass model to estimate the operation torque.

8. The collaborative robot system according to claim 7, wherein the at least one processor is programmed to establish the point mass model in which the arm and the workpiece in the operation of processing the workpiece are replaced with their masses concentrated at their centers of gravity.

9. The collaborative robot system according to claim 1, wherein the first threshold is selected to determine whether the robot collides with an external object.

10. The collaborative robot system according to claim 1, wherein the second threshold is selected to determine whether the external force is applied to the robot.

11. The collaborative robot system according to claim 1, wherein the third threshold is selected to determine whether the second differential torque has an unordinary value.

12. The collaborative robot system according to claim 11, wherein the third threshold is selected to reflect a difference between the estimated operation torque calculated where the mass of the workpiece is replaced with a load capacity of the robot and the estimated operation torque calculated where the mass of the workpiece is set equal to zero.

13. The collaborative robot system according to claim 11, wherein the third threshold is selected to reflect an average human force used to push the arm of the robot.
